(19) United States
(12) Patent Application Publication
(10) Pub. No.: US 2009/0182529 A1
(43) Pub. Date: Jul. 16, 2009

(54) DETERMINING SIGNAL QUALITY OF OPTICAL METROLOGY TOOL

(75) Inventors: Shahin Zangooie, Hopewell Junction, NY (US); Roger M. Young, Warwick, NY (US); Lin Zhou, LaGrangeville, NY (US)

Correspondence Address: HOFFMAN WARNICK LLC, 75 STATE ST, 14TH FL, ALBANY, NY, 12207, US

(73) Assignee: INTERNATIONAL BUSINESS MACHINES CORPORATION, Armonk, NY (US)

(21) Appl. No.: 12/013,614

(22) Filed: Jan. 14, 2008

(51) Int. Cl. G06F 17/18

(52) U.S. Cl. 702/179

(57) ABSTRACT

A method, system and computer program product for determining a signal quality of an optical metrology tool are disclosed. A method comprises: collecting a data pool regarding measurements of a target made by the optical metrology tool, the data pool including a wavelength of incident light used in a measurement; and statistically analyzing the data pool to obtain a wavelength specific signal quality of the optical metrology tool.

### BACKGROUND OF THE DISCLOSURE

1. Technical Field

The present disclosure relates in general to a processing system, and more particularly to determining a signal quality of an optical metrology tool used in the processing system.

2. Background Art

Utilization of optical metrology in semiconductor manufacturing has grown significantly over the past several years. The technology provides capabilities to conduct measurements of a wide variety of critical device parameters, including, for example, critical dimensions, depths and sidewall angles. The benefits of optical metrology include non-invasive and fast measurement capabilities with relatively low cost of ownership. The non-contact characteristic of the optical metrology is of great value as any time a contact is made to the surface of a device there is a possibility that the device could be damaged and/or contaminated. For optical metrology tools to yield measurement results that match, it is necessary that the optical metrology tools produce well defined incident light beams, and properly collect reflected light beams for analysis. Optical metrology tools are very complex machines with a large number of components such as lenses, polarizers, compensators, mirrors, diffraction gratings and detector arrays. Hence, slight variations among these optical components and their alignments can give rise to tool-to-tool matching problems. Therefore, these variations need to be controlled, modeled and compensated through appropriate calibration techniques. However, the existing calibration techniques are not able to take into account and model the entire array of components, aging, environmental and design related variables. It is thus important that additional matching controls based on, for example, signal qualities of optical metrology tools are implemented. The wavelengths signal quality in terms of, for example, signal stability and parameter sensitivity, can have a large impact on the accuracy and stability of the measurement values as well as tool to tool matching performance.

### SUMMARY

A first aspect of the disclosure is directed to a method for determining a signal quality of an optical metrology tool, the method comprising: collecting a data pool regarding measurements of a target made by the optical metrology tool, the data pool including a wavelength of a light beam used in a measurement; and statistically analyzing the data pool to obtain a wavelength specific signal quality of the optical metrology tool.

A second aspect of the disclosure is directed to a system for determining a signal quality of an optical metrology tool, the system comprising: means for collecting a data pool regarding measurements of a target made by the optical metrology tool, the data pool including a wavelength of a light beam used in a measurement; and means for statistically analyzing the data pool to obtain a wavelength specific signal quality of the optical metrology tool.

A third aspect of the disclosure is directed to a computer program product for determining a signal quality of an optical metrology tool, comprising computer usable program code which, when executed by a computer system, enables the computer system to: collect a data pool regarding measurements of a target made by the optical metrology tool, the data pool including a wavelength of a light beam used in a measurement; and statistically analyze the data pool to obtain a wavelength specific signal quality of the optical metrology tool.

A fourth aspect of the disclosure is directed to a method of determining an optical constant of a workpiece, the method comprising: measuring the workpiece with respect to the optical constant using multiple measurement tools; matching results of the measurements obtained by the multiple measurement tools; and determining the optical constant by interpolating the matched measurement results.

Other aspects and features of the present disclosure, as defined solely by the claims, will become apparent to those ordinarily skilled in the art upon review of the following non-limited detailed description of the disclosure in conjunction with the accompanying figures.

### BRIEF DESCRIPTION OF THE DRAWINGS

The embodiments of this disclosure will be described in detail, with reference to the following figures, wherein like designations denote like elements, and wherein:

FIG. 1 shows a block diagram of a system according to the disclosure.

FIG. 2 shows embodiments of a method for determining a finger print of an optical metrology tool.

FIG. 3 shows embodiments of a method for determining a sensitivity of an optical metrology tool to a measurement parameter.

FIG. 4 shows embodiments of a method for matching optical metrology tools with respect to determining an optical constant of a target.

It is noted that the drawings of the disclosure are not to scale. The drawings are intended to depict only typical aspects of the disclosure, and therefore should not be considered as limiting the scope of the disclosure. In the drawings, like numbering represents like elements among the drawings.

### DETAILED DESCRIPTION OF THE DISCLOSURE

The following detailed description of embodiments refers to the accompanying drawings, which illustrate specific embodiments of the disclosure. Other embodiments having different structures and operations do not depart from the scope of the present disclosure.

### 1. SYSTEM OVERVIEW

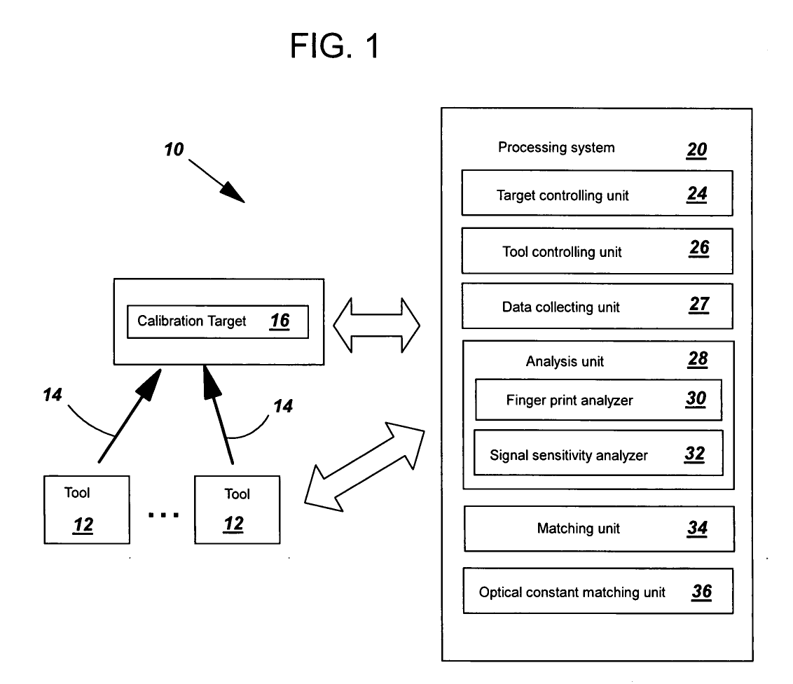

FIG. 1 shows a block diagram of a system 10 according to an embodiment of the invention. System 10 includes multiple optical metrology tools (tool) 12, a target 16, and a processing system 20. Each tool 12 may produce a light beam 14 to illuminate target 16. The produced light beam includes a spectrum, i.e., a range of wavelengths, used for the illumination. Processing system 20 includes a target controlling unit 24; a tool controlling unit 26; a data collecting unit 27; an analysis unit 28 including a finger print analyzer 30 and a signal sensitivity analyzer 32; a matching unit 34; and an optical constant matching unit 36.

In operation, processing system 20 may operate to determine a signal quality of tool 12. The signal quality refers to a quality of tool 12 with respect to the measurement of target 16. As variations in target 16 and tool 12 all contribute to the variations in the measurement results, the signal quality of tool 12 is evaluated with consideration of target 16 variations. According to an embodiment, the signal quality includes a finger print of tool 12 and a sensitivity of tool 12. A finger print of tool 12 refers to a signal quality of tool 12 with fixed measurement parameter settings. For example, a finger print includes signal stability of tool 12 indicated by a variation of measurements with fixed measurement parameter settings. A sensitivity of tool 12 refers to a variation of tool 12 finger print due to a variation in the setting of a measurement parameter.

According to an embodiment, processing system 20 may be implemented by a computer system. The computer system can comprise any general purpose computing article of manufacture capable of executing computer program code installed thereon to perform the process described herein. The computer system can also comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. The operation of system 10 will be described herein in detail.

### 2. DETERMINING FINGER PRINT OF OPTICAL METROLOGY TOOL

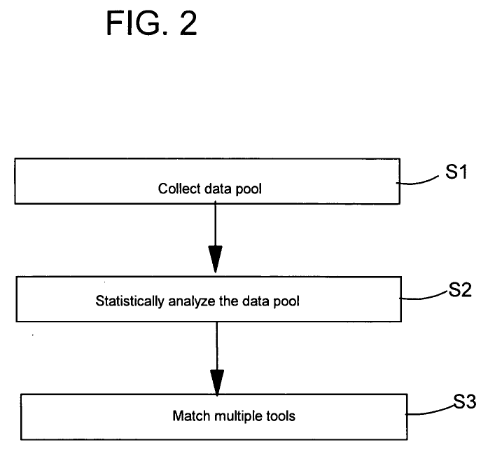

FIG. 2 shows embodiments of determining a finger print of a tool 12 in measuring target 16. A measurement parameter includes tool 12 parameters and target 16 parameters. A fixed parameter setting means that the parameter value will not be intentionally changed in a resetting of tool 12 and/or target 16. However, it should be appreciated that a fixed parameter setting may still actually end up with actually varied parameter values due to various reasons. For example, an actual value of an autofocus of a tool 12 may change each time the autofocus is reset even if the resetting aims at the same fixed focus target, i.e., fixed autofocus setting. For another example, an actual position of target 16 may change each time target 16 is re-fed into a process chamber and realigned by a robotic arm, even if the re-feeding and realigning aim at the same specific fixed position of target 16, i.e., fixed target 16 position setting. A measurement parameter may be any parameter of tool 12 and/or target 16 that may affect a measurement of target 16 made by tool 12. According to an embodiment, the measurement parameter may include a focus of tool 12 and a position of target 16.

Referring to FIGS. 1-2, collectively, in process S1, data collecting unit 27 collects a data pool regarding measurements of target 16 made by a tool 12. Each data entry in the data pool may include multiple attributes, one of which may be the wavelength of light beam 14 used for the measurement. Data entry attributes may also include a characteristic of light beam 14 which affect the measurement of target 16. Any characteristic of light beam 14 may be collected, and all are included. For example, the characteristic may be light beam strength, incident angle, Azimuth angle, incident beam spot size, etc.

Each data entry may also include an attribute of a measurement result of target 16, for example, a measured optical constant (usually referred to as “n&k”), and a critical dimension of target 16.

According to an embodiment, preferably, the data pool includes multiple data entries for each relevant light beam 14 wavelength (or wavelength). A relevant light beam wavelength refers to a wavelength at which tool 12 measures target 16. Further, as wavelengths of a light beam 14 are substantially continuous, the range of the continuous wavelengths may be divided into wavelength points for analysis purposes. A relevant light beam 14 wavelength may be further limited to the wavelength points.

In an embodiment, data obtained by tool 12 in actual measurement operations may be collected in process S1. According to an alternative embodiment, preferably, data entries of the data pool are collected through measurements of target 16 particularly for determining the finger print of tool 12. Specifically, tool controlling unit 26 and target controlling unit 24 coordinate to control tool 12 to make multiple or repeated measurements of target 16 at each relevant wavelength to generate the data entries of the data pool. For each repeated measurement, a measurement parameter of at least one of tool 12 or target 16 may be reset. For example, tool controlling unit 26 and/or target controlling unit 24 may reset at least one of a focus (typically autofocus) of tool 12 or a position of target 16. In process S1, the resetting aims at the same parameter setting, i.e., fixed parameter setting. That is, for example, the autofocus of tool 12 is reset to focus on the same focus target, and target 16 is reset to be at the same position. As described above, the actual autofocus of tool 12 and/or actual position of target 16 may be varied due to a resetting although the resetting aims to achieve the same autofocus and/or position.

In resetting a measurement parameter, e.g., the position of target 16, data collecting unit 27 may instruct target controlling unit 24 and/or tool controlling unit 26 regarding which mechanism(s) is reset in the resetting. For example, multiple mechanisms may be involved in the positioning of target 16, e.g., robotic arm and/or wafer aligner, and data collecting unit 27 may instruct target controlling unit 24 to reset only the wafer aligner. As a consequence, the influence of the robotic arm will not be considered in determining the finger print.

In process S2, finger print analyzer 30 of analysis unit 28 statistically analyzes the data pool to determine a finger print of tool 12. The finger print includes a statistical signal quality index (index) value for each relevant wavelength. Any statistical analysis method may be used to analyze the data pool to obtain the index value and all are included. For example, the average and/or standard deviation of the measurements of target 16, e.g., the measured n&k, at each relevant wavelength may be obtained to indicate a data quality of the tool 12 at the wavelength, i.e., index value. For example, the standard deviation of the measurements may indicate a signal stability of tool 12. The index values at all relevant wavelengths comprise the finger print of the tool 12 for that specific index, e.g., average n&k measurement.

In process S3, analysis unit 28 outputs the finger prints of multiple tools 12 to matching unit 34 to match the multiple tools 12 based on the respective finger prints. Any method may be used in the matching, and all are included. For example, matching unit 34 may set a threshold (e.g., an allowable range including an upper threshold and lower threshold) for the index value of each tool 12 at each wavelength. If the index value of a tool 12 meets the threshold (e.g., within the range), the tool 12 is considered as matching other tools 12 at the specific wavelength; if the index value of tool 12 does not meet the threshold, the tool 12 is considered not matching other tools 12 at the specific wavelength. In the matching, multiple types of finger prints of a tools 12 (i.e., multiple types of indices) may be used to further refine the matching. For example, a tool 12 may be considered a matching tool with respect to the average n&k measurement at a wavelength, but may be a non-matching tool with respect to the standard deviation of the n&k measurements at the same wavelength. For a non-matching tool 12 having some given signal quality indices, e.g., average n&k measurement, at a wavelength, tool matching unit 34 may adjust the measurements of the tool 12 at the wavelength, e.g., using weights, to make the tool 12 matching. For some other indices, e.g., the standard deviation at a wavelength, the non-matching wavelength of the non-matching tool 12 may have to be eliminated from operation (referred to as a “cut-off” wavelength) to make the tool 12 match other tools 12.

### 3. DETERMINING SENSITIVITY TO MEASUREMENT PARAMETER

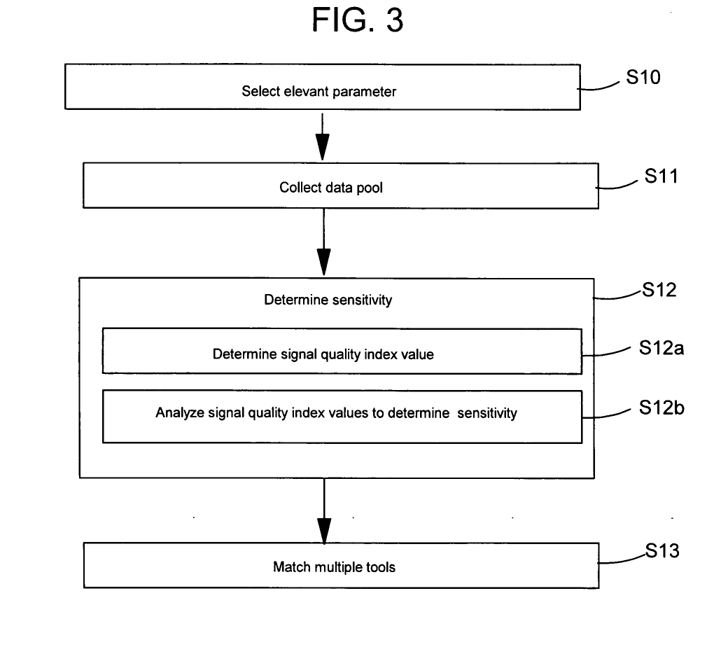

A tool 12 sensitivity to a measurement parameter refers to a variation in the finger print of the tool 12 resulting from a (unit) variation in the measurement parameter. In this description, tool sensitivity is defined as wavelength specific. That is, the sensitivity of a tool 12 is evaluated with respect to a wavelength and is represented by the variation in the signal quality index value. FIG. 3 shows a method of determining a tool 12 sensitivity to a measurement parameter. Referring to FIGS. 1 and 3 collectively, in process S10, signal sensitivity analyzer 32 selects a relevant measurement parameter. A relevant measurement parameter refers to a measurement parameter to which a sensitivity of tool 12 is to be determined.

In process S11, data collecting unit 27 collects a data pool regarding measurements of target 16 made by a tool 12. Each data entry of the data pool includes a light beam wavelength used in the measurement as an attribute. Process S11 may be performed following the similar procedures of process S1 of FIG. 2, except that the resetting of a measurement parameter(s) includes intentionally varying a setting of the relevant measurement parameter(s). In an embodiment, the varying of the relevant measurement parameter setting may be repeated, and in each repeating, the amount of variation may be different. As a consequence, the data pool may include multiple data entries of the same relevant wavelength but with different settings of the relevant measurement parameter.

In process S12, signal sensitivity analyzer 32 of analysis unit 28 determines a sensitivity of tool 12 to a relevant measurement parameter. The analysis may include two sub-processes. In sub-process S12a, signal sensitivity analyzer 32 may instruct finger print analyzer 30 to determine a signal quality index value for a tool 12 at each relevant wavelength and with each different setting of the relevant measurement parameter, following the methods of FIG. 2. In sub-process S12b, signal sensitivity analyzer 32 may analyze the index values with respect to the respective settings of the relevant measurement parameter to determine the sensitivity of tool 12 to the relevant measurement parameter. Any method may be used to determine the sensitivity, and all are included. For example, the index values with different parameter settings for a given wavelength may be compared and the differences may be used to determine the sensitivity. For an illustrative example, it is assumed that at a relevant wavelength, the results of process S12a and S12b are shown in table 1:

TABLE 1

| | Attributes | | | |
|---|---|---|---|---|
| Case number | Parameter setting | Index Value | Sensitivity | |
| 1 | Base | 5 | | |
| 2 | Base + 1 unit | 6 | 1 | per unit |
| 3 | Base + 2 units | 8 | 1.5 | per unit |
| 4 | Base + 3 units | 9.5 | 1.5 | per unit |
| 5 | Base + 4 units | 9 | 1 | per unit |
| Average sensitivity | | | 1.25 | per unit |

In Table 1, for illustrative purposes, a sensitivity value of a case (case numbers 2-5) is determined relative to case 1 using “Base” parameter setting. For example, sensitivity of case 3=(8−5)/(base+2 units−base)=1.5/unit. In an actual implementation of the methods, multiple methods for calculating the sensitivity values may be used. For example, the sensitivity of case 3 may also be accessed based on the differences of case 3 to case 2 and case 4. The average sensitivity may be used to indicate the sensitivity of a tool 12 to the relevant measurement parameter at the given wavelength.

For another example, the index values and the different parameter settings at a wavelength may be fitted to produce a regression equation, e.g., index value=a*parameter setting+b. The coefficient “a” may be used to indicate the sensitivity to the relevant measurement parameter.

Using sub-processes S12a and S12b, signal sensitivity analyzer 32 may obtain the sensitivity of a tool 12 to a relevant measurement parameter, e.g., tool 12 autofocus, at each relevant wavelength.

In process S3, analysis unit 28 outputs the sensitivities of multiple tools 12 to matching unit 34 to match the multiple tools 12 based on the respective sensitivities. Any method may be used in the matching, and all are included. According an embodiment, the sensitivities of tools 12 are used in combination with the finger prints thereof in the matching. The matching process may implement the IBM Total Measurement Uncertainty (TMU) methods (U.S. Pat. No. 7,085,676) and the Fleet Matching Precision (FMP) methods (United State Patent Publication Number US20060195294A1) to confirm accuracy and matching quality of tools 12 based on the finger prints and the sensitivities. According to an embodiment, the above described finger print and sensitivity determination operations may be used in determining an optical constant (n&k) of target 16, e.g., a workpiece, as will be described herein.

### 3. DETERMINING OPTICAL CONSTANT OF A TARGET WAFER

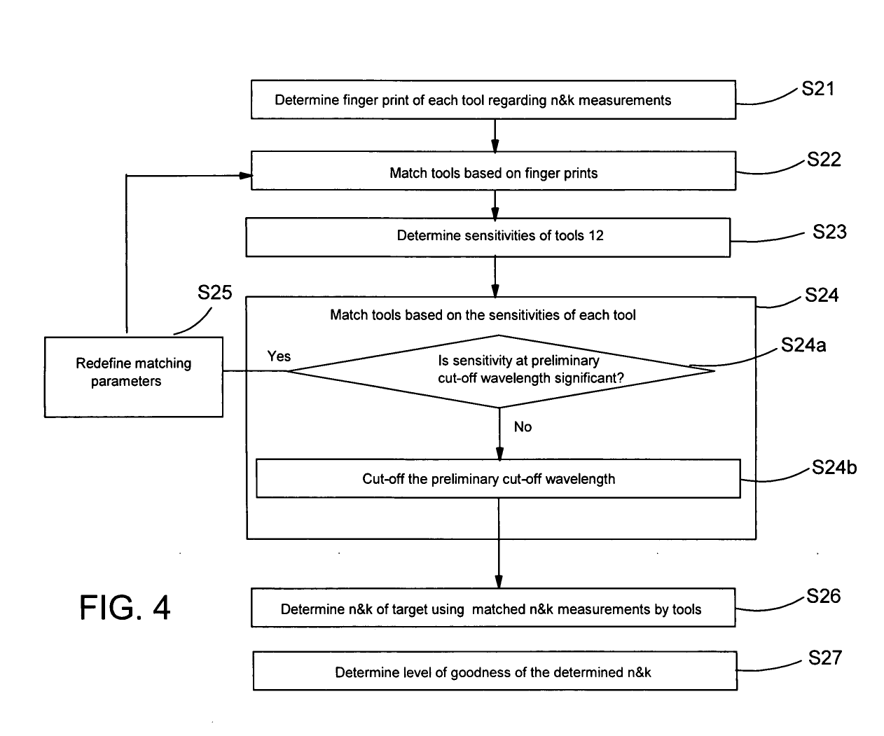

As tools 12 may be used to measure an optical constant (n&k) of a target 16, the measurement results, i.e., measured n&k, may be used to further match tools 12 and the matching operations may result in a finally determined n&k of target 16. FIG. 4 shows a flow diagram of a method of matching n&k. Referring to FIGS. 1 and 4 collectively, in process S21, finger print analyzer 30 determines a finger print of each tool 12 regarding n&k measurements.

In process S22, matching unit 34 matches tools 12 based on the n&k finger prints. The matching may include determining matching parameters including a weight applied to the n&k measurements of a tool 12 and/or a threshold to determine a preliminary cut-off wavelength (wavelength range) of a tool 12 as described above. In process S22, the determined cut-off wavelength is preliminary to the extent that the possible cut-off will be further evaluated based on the sensitivity of the tool 12 at the preliminary cut-off wavelength.

In process S23, signal sensitivity analyzer 32 determines sensitivities of tools 12 regarding n&k measurements at each relevant wavelength.

In process S24, matching unit 34 further matches tools 12 based on the sensitivities of each tool 12. Specifically, for example, in sub-process S24a, matching unit 34 may further determine whether the preliminary cut-off wavelength (wavelengths range) of a tool 12 is significant (according to a preset standard). For example, matching unit 34 may be preset to identify a sensitivity larger than, for example, a random noise, as significant. The finger print may be used to determine a random noise. If the preliminary cut-off wavelength provides a sensitivity response that is larger than the random noise and are comparable to the sensitivity in other wavelength ranges, a user of system 10 may decide to keep the preliminary cut-off wavelength if necessary. Then in process S25, matching unit 34 may redefine the matching parameters, e.g., weights and thresholds to determine a preliminary cut-off wavelength. The operation proceeds with process S22 with the redefined matching parameters. If the sensitivity at the preliminary cut-off wavelength is insignificant, in sub-process S24b, the preliminary cut-off wavelength will be cut off/eliminated, i.e., the tool 12 will not use the cut-off wavelength to make n&k measurements of target 16 or the n&k measurements by the tool 12 at the cut-off wavelength will not be used.

In process S26, optical constant matching unit 36 determines an n&k of target 16 using the matched n&k measurements of tools 12. The matched measurements may be measurements that are weighted and filtered by the wavelength cut-off. The determination may be based on any method and all are included. For example, an interpolation of the matched n&k measurements using optimized dispersions may be used for the determination. The interpolation scheme may be as simple as simple averaging the matched measurements, or may include any other known scheme such as spline interpolation. Further, the matched n&k measurements may include n&k measurements at different measurement parameter settings, e.g., different environmental temperatures. The information of the different measurement parameters, as related to the matched n&k measurements, may be used in the interpolation and may further establish a relationship between the n&k and the parameter settings. For example, the n&k may be determined as a function of the temperature so that an n&k at a specific temperature may be determined without an actual measurement.

In process S27, optionally, optical constant matching unit 36 may determine a level of goodness of the determined optical constant. The level of goodness may be determined with any methods, and all are included. For example, a pre-determined relationship between n&k and a measurement parameter may be used to check whether the interpolated n&k fits the relationship. The Kramers Kronig (K&K) relationship check may also be used to determine the level of goodness of the determined n&k of target 16.

### 4. CONCLUSION

While shown and described herein as a method and system for determining a signal quality of an optical metrology tool, it is understood that the disclosure further provides various alternative embodiments. For example, in an embodiment, the disclosure provides a program product stored on a computer-readable medium, which when executed, enables a computer infrastructure to determine a signal quality of an optical metrology tool. To this extent, the computer-readable medium includes program code, which may be installed to a computer system to implement, e.g., processing system 20 (FIG. 1), to implement the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as a memory and/or a storage system and/or as a data signal traveling over a network (e.g., during a wired/wireless electronic distribution of the program product).

It should be appreciated that the teachings of the present disclosure could be offered as a business method on a subscription or fee basis. For example, a system 10 (FIG. 1) including processing system 20 and a targets 16 could be created, maintained and/or deployed by a service provider that offers the functions described herein for customers. That is, a service provider could offer to determine a signal quality of an optical metrology tool as described above.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that the terms “component” and “system” are synonymous as used herein and represent any combination of hardware and/or software capable of performing some function(s).

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the disclosure has other applications in other environments. This application is intended to cover any adaptations or variations of the present disclosure. The following claims are in no way intended to limit the scope of the disclosure to the specific embodiments described herein.

What is claimed is:

1. A method for determining a signal quality of an optical metrology tool, the method comprising:
collecting a data pool regarding measurements of a target made by the optical metrology tool, the data pool including a wavelength of a light beam used in a measurement; and
statistically analyzing the data pool to obtain a wavelength specific signal quality of the optical metrology tool.

2. The method of claim 1, wherein the collecting includes collecting data regarding measurements made with a same measurement parameter setting at a given wavelength, and the analyzing includes statistically analyzing the measurements to determine the signal quality of the optical metrology tool at the given wavelength.

3. The method of claim 2, wherein the analyzing includes analyzing an average and a standard deviation of the measurements at the given wavelength.

4. The method of claim 1, wherein the collecting includes collecting data regarding measurements made with different settings of a measurement parameter at a given wavelength, and the analyzing includes determining a sensitivity of the measurements at the given wavelength to a variation in the measurement parameter settings.

5. The method of claim 1, further comprising matching multiple optical metrology tools based on the wavelength specific signal quality of each optical metrology tool.

6. The method of claim 5, wherein the matching includes:
determining an initial cut-off wavelength based on a finger print of a given optical metrology tool; and
determining whether to eliminate the initial cut-off wavelength for the given optical metrology tool based on a sensitivity of the given optical metrology tool to a measuring parameter variation at the initial cut-off wavelength.

7. The method of claim 5, further comprising determining an optical constant of the target using matched measurements of the optical constant made by the multiple optical metrology tools.

8. The method of claim 7, further comprising determining a level of goodness of the determined optical constant.

9. A system for determining a signal quality of an optical metrology tool, the system comprising:
means for collecting a data pool regarding measurements of a target made by the optical metrology tool, the data pool including a wavelength of a light beam used in a measurement; and
means for statistically analyzing the data pool to obtain a wavelength specific signal quality of the optical metrology tool.

10. The system of claim 9, wherein the collecting means collects data regarding measurements made with a same measurement parameter setting at a given wavelength, and the analyzing means statistically analyzes the measurements to determine the signal quality of the optical metrology tool at the given wavelength.

11. The system of claim 9, wherein the collecting means collects data regarding measurements made with different settings of a measurement parameter at a given wavelength, and the analyzing means determines a sensitivity of the measurements at the given wavelength to a variation in the measurement parameter settings.

12. The system of claim 9, further comprising means for matching multiple optical metrology tools based on the wavelength specific signal quality of each optical metrology tool.

13. The system of claim 12, wherein the matching means:
determines an initial cut-off wavelength based on a finger print of a given optical metrology tool; and
determines whether to eliminate the initial cut-off wavelength for the given optical metrology tool based on a sensitivity of the given optical metrology tool to a measuring parameter variation at the initial cut-off wavelength.

14. The system of claim 12, further comprising means for determining an optical constant of the target using matched measurements of the optical constant made by the multiple optical metrology tools, and means for determining a level of goodness of the determined optical constant.

15. A computer program product for determining a signal quality of an optical metrology tool, comprising computer usable program code which, when executed by a computer system, enables the computer system to:
collect a data pool regarding measurements of a target made by the optical metrology tool, the data pool including a wavelength of a light beam used in a measurement; and
statistically analyze the data pool to obtain a wavelength specific signal quality of the optical metrology tool.

16. The program product of claim 15, wherein the program code is configured to enable the computer system to collect data regarding measurements made with a same measurement parameter setting at a given wavelength, and to statistically analyze the measurements to determine the signal quality of the optical metrology tool at the given wavelength.

17. The program product of claim 15, wherein the program code is configured to enable the computer system to collect data regarding measurements made with different settings of a measurement parameter at a given wavelength, and to determine a sensitivity of the measurements at the given wavelength to a variation in the measurement parameter settings.

18. The program product of claim 15, wherein the program code is further configured to enable the computer system to match multiple optical metrology tools based on the wavelength specific signal quality of each optical metrology tool.

19. The program product of claim 18, wherein the program code is further configured to enable the computer system to determine an optical constant of the target using matched measurements of the optical constant made by the multiple optical metrology tools, and to determine a level of goodness of the determined optical constant.

20. A method of determining an optical constant of a workpiece, the method comprising:
measuring the workpiece with respect to the optical constant using multiple measurement tools;
matching results of the measurements obtained by the multiple measurement tools; and
determining the optical constant by interpolating the matched measurement results.
